(19) United States
(12) Patent Application Publication
(10) Pub. No.: US 2006/0230146 A1
(43) Pub. Date: Oct. 12, 2006

(54) Method for generating super frame by using sub-frame in residential ethernet system

(75) Inventors: Sihai Wang, Suwon-si (KR); Sang-Ho Kim, Hwaseong-si (KR); Jae-Hun Cho, Seoul (KR); Fei-Fei Feng, Suwon-si (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/375,830

(22) Filed: Mar. 15, 2006

(30) Foreign Application Priority Data
Mar. 15, 2005 (KR) 2005-21594

(51) Int. Cl. G06F 15/173

(52) U.S. Cl. 709/225

(57) ABSTRACT

A method for generating a super frame of a predetermined size in a a residential Ethernet system for separately transmitting isochronous data and asynchronous data includes the steps of: receiving by the residential Ethernet system the isochronous data and the asynchronous data to be transmitted through the residential Ethernet system; dividing the received isochronous data into a plurality of sub-frames according to synchronous links; inserting an Ethernet header into each of the sub-frames, thereby generating a plurality of isochronous packets; and employing a remaining area, which is obtained by excepting an area of the isochronous packets from the predetermined size, as an asynchronous packet area, and inserting asynchronous packets including the asynchronous data into the asynchronous packet area.

### CLAIM OF PRIORITY

This application claims priority to an application entitled “Method For Generating Super Frame By Using Sub-frame In Residential Ethernet System,” filed in the Korean Intellectual Property Office on Mar. 15, 2005 and assigned Serial No. 2005-0021594, the contents of which are hereby incorporated by reference.

### BACKGROUND OF THE INVENTION

1. Field of the Invention

The present invention relates to a residential Ethernet, and more particularly to a method of generating a super frame in a residential Ethernet system to improve a Bandwidth Utilization Rate (BUR) and increase the efficiency of a switching operation.

2. Description of the Related Art

Ethernet relates to a local area communication network, which is defined in a standard by the Institute of Electrical and Electronics Engineers (IEEE) 802.3 as a standard.

Since the conventional Ethernet accesses a frame by means of a Carrier Sense Multiple Access/Collision Detect (CSMA/CD) protocol defined in an IEEE 802.3, an upper layer of the service frames has to be converted to Ethernet frames for transmission while maintaining an Inter Frame Gap (IFG) interval. The Ethernet transmits the Ethernet frames in a generation sequence regardless of the type of the upper service frame, thus the Ethernet may be used universally to transmit data among a plurality of different terminals or users.

However, since such Ethernet uses a CSMA/CD scheme for assigning the same priority to all Ethernet frames, it has been known as a technology which is not suitable for transferring dynamic images or voice data sensitive to a transmission time delay.

Nowadays, as dynamic images or voice data sensitive to transmission time delays occupy a large portion of data transmission, new schemes have been proposed which can overcome the delay problems while maintaining the Ethernet scheme. For example, a residential Ethernet has been proposed as one method of such real-time communication.

A direct solution of Ethernet-based real-time communication is to directly encapsulate real-time data into an Ethernet frame, perform global time synchronization, and adjust bandwidth reservation and entrance/exit. In this way, it is possible to theoretically process real-time communication. However, if this method is used, a BUR becomes intolerable when considering the characteristics of real-time communication.

For example, an audio CD and a digital TV require bandwidths of 1.5 Mbps and 20 Mbps, respectively. In order to perform a real-time communication, a receiver buffer must generally have an interval greater than 125 μs (defined by intervals). This represents that a destination apparatus requires 24 byte data for an audio CD and 320 byte data for a digital TV every 125 μs. If 24 bytes of data and 320 bytes of data are directly encapsulated into Ethernet frames, respectively, BURs are about 28% and 89%, respectively (in a capsule processing of 24 bytes of data, it is possible to insert 22 bytes of pad in order to obtain a minimum frame length of 64 bytes. In fact, many applications have BURs smaller than that of an audio CD.

FIG. 1 is a diagram illustrating the structure of a transmission cycle in conventional residential Ethernet.

As illustrated in FIG. 1, conventional residential Ethernet constructs a transmission cycle for data transmission as one cycle 10 in a unit of 125 μs. Each cycle includes an async frame interval 110 for transmission of asynchronous data and a sync frame interval 100 for transmission of synchronous data.

Specifically, the sync frame interval 100 for transmission of synchronous data represents the highest priority in the transmission cycle. According to a proposal being currently discussed, the sync frame interval 100 includes sub-sync frames 101 to 103, each of which has 738 bytes (the proposal may change).

The async frame interval 110 for transmission of asynchronous data includes sub-async frames 111 to 113, each of which has a variable size in a corresponding area.

FIG. 2 is a diagram illustrating the structure of the sub-sync frame included in the transmission cycle of the conventional residential Ethernet.

As illustrated in FIG. 2, the sub-sync frame of the conventional residential Ethernet includes an Ethernet header 21, a sync header 22, a Header Check Sequence (HCS) 23 for checking header information, a sync data slot 24, and a Frame Check Sequence (FCS) 25 for detecting a transmission error. The Ethernet header 21 is comprised of 22 octets and includes header information such as a destination address, a source address, type information, etc. of an Ethernet frame. The sync header 22 is comprised of 32 bytes and includes information on a synchronization frame such as synchronization or non-synchronization, frame counter information, cycle counter information, etc. The sync data slot 24 is comprised of 768 bytes and includes synchronous Ethernet data to be transmitted, which have 192 sync data slots of 4 bytes.

The sync data slot 24 includes a set of data slots 241, 242, etc., each of which has a size of 4 bytes, and each synchronous Ethernet data are divided into the data slots 241, 242, etc. and transmitted.

In this case, when a server transmits synchronous Ethernet data to users, the sync data slot 24 includes the synchronous Ethernet data for each user in a form of a slot. Therefore, since the synchronous Ethernet data are not unicast to each user, but are multicast to each user, each user apparatus must process its own data according to data slots.

The destination address included in the Ethernet header 21 represents not the destination address of each Ethernet synchronous data but the destination address indicating an Ethernet switch for a final routing. Accordingly, the destination address is different from the destination of Ethernet synchronous data specifying each user.

In the method as described above, a slot corresponds to a basic transmission unit, a plurality of slots belong to various applications, or links of digital media communication are encapsulated into one Ethernet frame. Therefore, since a BUR shares a frame, it considerably increases. However, in this method, a slot simply transmits data and does not transmit any useful information for a link or a switching operation, such as a destination address or a source address of an Ethernet frame. Further, a switch apparatus stores a table of all input/output slot position information for a slot switching and slot position information of various links for management purposes. For a 1 Gbps Ethernet link, more than 3000 slots are required for each port per one period. Accordingly, in order to store position information of all slots, a slot switching table of a large size is required within a switch. Further, the slot switching table is accessed from slot a slot whenever a switching is performed, thus is frequently altered whenever a link is connected or removed.

As described above, residential Ethernet of a slot scheme is very complicated as compared with traditional Ethernet, and further requires incorporation of many apparatuses.

### SUMMARY OF THE INVENTION

Accordingly, the present invention has been made to solve the above-mentioned problems occurring in the prior art and provides additional advantages, by providing a method for generating a super frame in a residential Ethernet system, which can improve a BUR by proposing a sub-frame structure for transmission of a variable synchronization frame, instead of processing a slot as in the residential Ethernet system.

In accordance with one aspect of the embodiment, there is provided a method for generating a super frame of a predetermined size in a residential Ethernet system for separately transmitting isochronous data and asynchronous data, the method including the steps of: receiving by the residential Ethernet system the isochronous data and the asynchronous data to be transmitted through the residential Ethernet system; dividing the received isochronous data into a plurality of sub-frames according to synchronous links; inserting an Ethernet header into each of the sub-frames, thereby generating a plurality of isochronous packets; and employing a remaining area, which is obtained by excepting an area of the isochronous packets from the predetermined size, as an asynchronous packet area, and inserting asynchronous packets including the asynchronous data into the asynchronous packet area.

### BRIEF DESCRIPTION OF THE DRAWINGS

The above features and advantages of the present invention will be more apparent from the following detailed description taken in conjunction with the accompanying drawings, in which:

FIG. 1 is a diagram illustrating the structure of a transmission cycle in the conventional residential Ethernet;

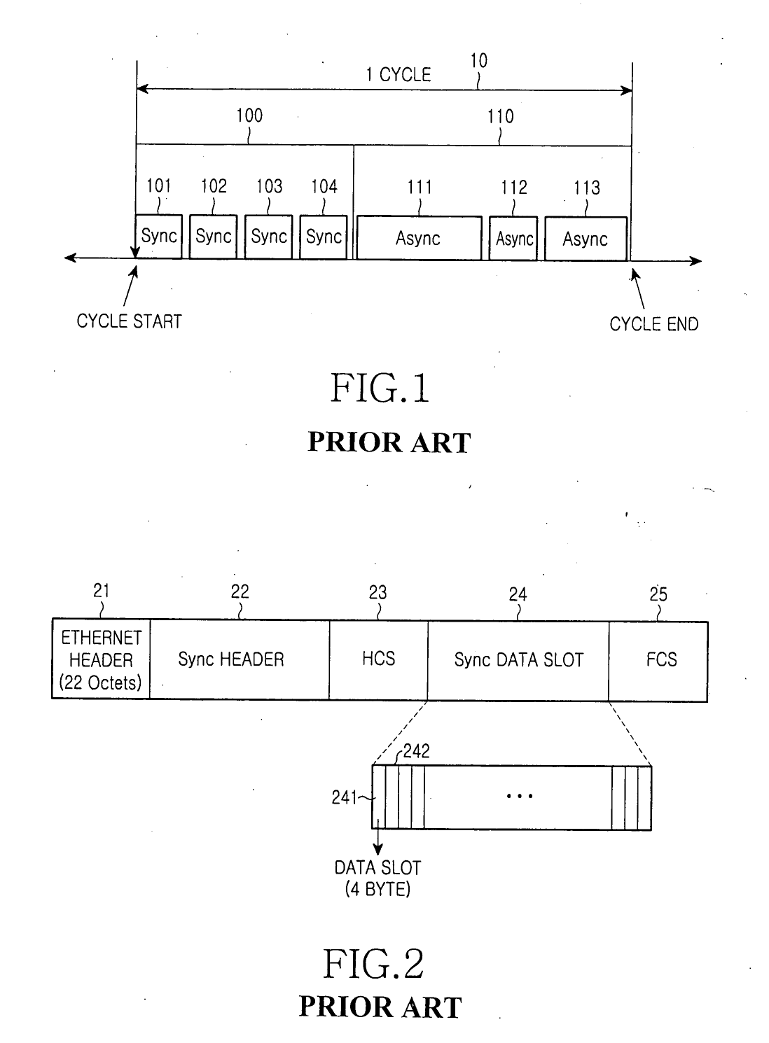

FIG. 2 is a diagram illustrating the structure of a sub-sync frame included in a transmission cycle of the conventional residential Ethernet;

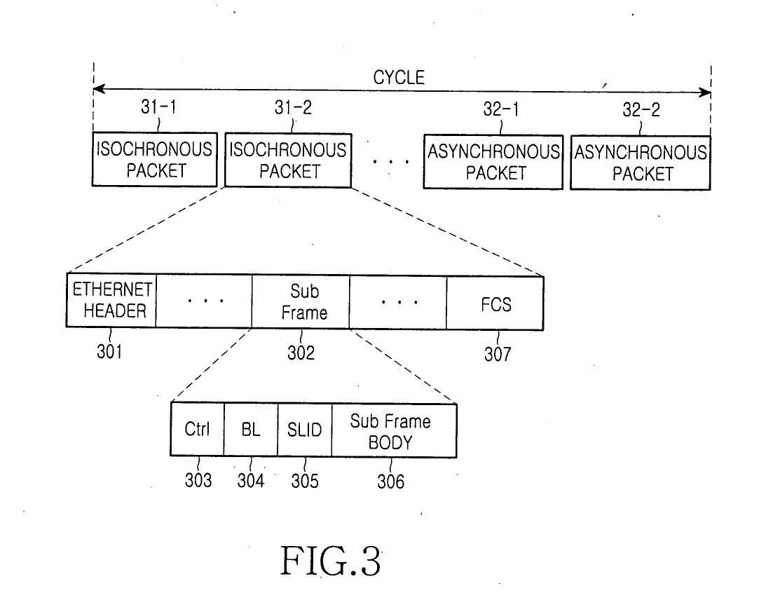

FIG. 3 is a diagram illustrating the structure of a transmission cycle in the residential Ethernet according to one embodiment of the present invention;

FIG. 4 is a diagram illustrating the structure of a sub-frame in the residential Ethernet according to one embodiment of the present invention;

FIG. 5 is a diagram illustrating the construction of a switching table in the residential Ethernet according to the embodiment of the present invention; and

FIGS. 6a and 6b are diagrams illustrating the switching process of a sub-frame in the residential Ethernet according to the embodiment of the present invention.

### DETAILED DESCRIPTION

An embodiment of the present invention will be described in detail herein below with reference to the accompanying drawings. The same reference numerals are used to designate the same elements as those shown in other drawings. In the following description, particular items such as detailed elements are shown, but these are provided for helping the general understanding of the present invention, it is apparent to those skilled in the art that the particular items can be modified or changed within the range of the present invention.

According to the teachings of the present invention, a plurality of isochronous packets are inserted into a synchronous frame intervaland includes slot data, data according to destinations are made into sub-frames, and the sub-frames are inserted into a corresponding isochronous packet and transmitted.

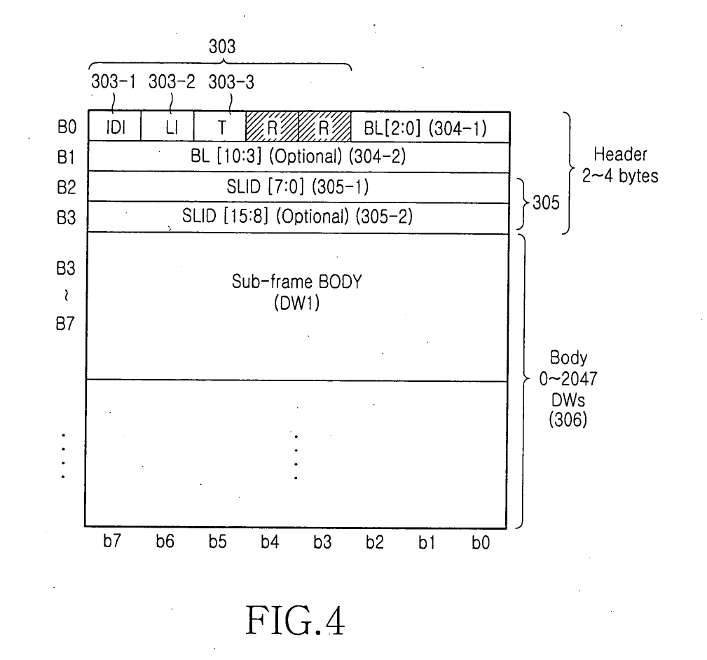

FIG. 3 is a diagram illustrating the structure of a transmission cycle in the Residential Ethernet (RE) according to one embodiment of the present invention.

Referring to FIG. 3, the transmission cycle in the RE according to the embodiment is divided by each interval (basic interval for synchronous link) of 125 μs in consideration of synchronization of a time axis. Each interval includes a plurality of isochronous packets 31-1 and 31-2 and asynchronous packets 32-1 and 32-2. The isochronous packets 31-1 and 31-2 are first transmitted and then the asynchronous packets 32-1 and 32-2 are transmitted. Since the format and processing of the asynchronous packet are the same as those of conventional Ethernet, details will be omitted to avoid redundancy in the embodiment of the present invention.

Hereinafter, the isochronous packets 31-1 and 31-2 will be described in detail. Each of the isochronous packets 31-1 and 31-2 includes an Ethernet header 301 and sub-frames having multiple variable lengths within a frame body terminated by a Frame Checksum Sequence (FCS) 307.

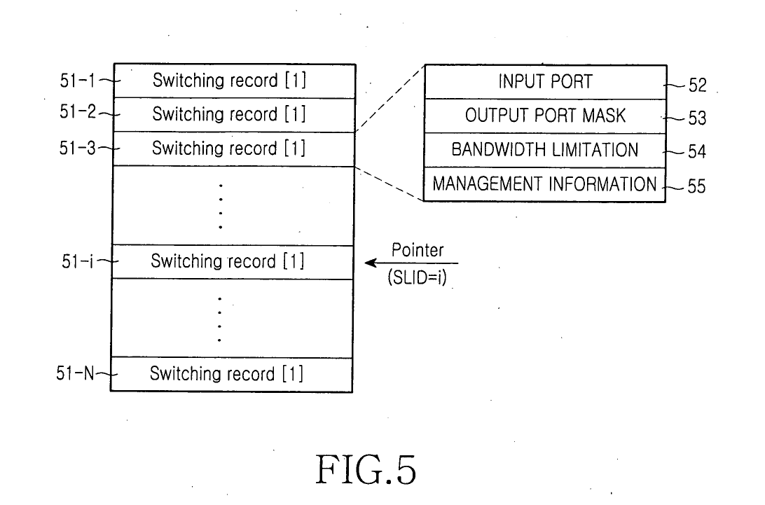

Each of the sub-frames includes a control field 303, a body length field 304, a synchronous link identifier field 305, and a sub-frame body field 306. The sub-frame will be described in detail with reference to FIG. 4.

FIG. 4 is a diagram illustrating the structure of the sub-frame in the RE according to one embodiment of the present invention.

Referring to FIG. 4, in the sub-frame in the RE according to the embodiment, a horizontal axis is expressed by the number of bits and a vertical axis is expressed by a byte. The sub-frame includes the control field 303, the body length field 304, the synchronous link identifier field 305, and the sub-frame body field 306.

The control field 303 is comprised of five bits (B0, b7 to b3). In the control field 303, three bits (B0, b7 to b5) are used for the body length field 304, the synchronous link identifier field 305, and a sub-frame type. The remaining two bits (B0, b4 to b3) are reserved for future use.

The body length field 304 is for indicating the body length of the sub-frame by a Double Word Unit (DW, four bytes). The body length field 304 is divided into two parts. Between the two parts, one (B0, b2 to b0) 304-1 is a mandatorily assigned part and the other (B1) 304-2 is a selectively usable part.

For the sub-frame (below 8 DW) with a short length, the Length Indicator (LI) field 303-2 of the control field 303 is set to “0”, and the selectively usable body length field 304-2 is removed in order to shorten the header length of the sub-frame and improve the efficiency of a bandwidth. If the sub-frame has a length more than 8 DW, the LI field 303-2 of the control field 303 is set to “1” and the selectively usable body length field 304-2 is maintained. However, in this case, since bandwidth efficiency is high enough, it is insensitive to the header length of the sub-frame.

The body length field 304 is necessary for delimitation of the sub-frame. For example, the body length field 304 aids another operation such as a bandwidth computation.

The synchronous link identifier field 305 is for indicating a synchronous link including a corresponding sub-frame, and is divided into two parts as the case of the body length field 304. Between the two parts, one (B2) 305-1 is a mandatorily assigned part and the other (B3) 305-2 is a selectively usable part.

If the number of synchronous links is smaller than 256 in a local network, the IDI field 303-1 of the control field 303 is set to “0”, and the selectively usable synchronous link identifier field 305-2 is removed. However, if the number of the synchronous links is not less than 256 in the local network, the IDI field 303-1 of the control field 303 is set to “1”, and the selectively usable synchronous link identifier field 305-2 is maintained. In this case, the number of total links increases to “65535”. The synchronous link identifier field 305 is used for the switching of the sub-frame. All switch apparatuses according to a synchronous link must store switching information, and the switching information is indexed and accessed by a synchronous link identifier.

The “T” bit 303-3 of the control field 303 is used for indicating if a sub-frame corresponds to synchronous data transmission. In the embodiment of the present invention, when the “T” bit 303-3 is set to “0”, it indicates synchronous data transmission. That is, it represents that all data are carried through the sub-frame body field 306 with sizes of 0˜2047 DW. The sub-frame has a maximum length of 2047 DW (or 8188 bytes), and this is longer than that of a conventional Ethernet frame currently in use. Accordingly, it can be applied to a jumbo Ethernet frame to be used for future use. If a jumbo Ethernet frame is not widely used, a sub-frame with a long length may be divided into a plurality of segments having identical sub-frame headers.

If the “T” bit 303-3 of the control field 303 is set to “1”, it represents that a synchronization control, management, and operation message are transmitted through a sub-frame body.

The synchronization control, management, and operation message includes information relating to a bandwidth reservation, a synchronization switching table operation, a device type discovery, a synchronization transmission control, a medium device control, and negotiation, etc.

Such a synchronization Control and Management Sub-Frame (CMSF) is encapsulated into an isochronous packet for an immediate response. Another operation messages (e.g. messages used for acquisition of time synchronization and a synchronous link identifier) must be transmitted through an asynchronous packet. The detailed format of such a CMSF will not be described here.

The structure of the sub-frame in the RE described in FIG. 4 is summarized through table 1 below.

TABLE 1

| Name | Byte.bit | Description |
|---|---|---|
| IDI | 0.7 | SLID-field indicator. |
| | | 0: short. Only B2 is presented and SLID ranges from 0 to 255. |
| | | 1: long. Both B2 and B3 are presented and SLID ranges from 0 |
| | | to 65535. |
| LI | 0.6 | Length-field indicator. |
| | | 0: short. Only bit 0.2˜0.0 used for SF body length field. In this |
| | | case, the body length of a sub-frame ranges from 0 to 7 DWs |
| | | (0 to 28 bytes). |
| | | 1: long. Only additional byte B1 in header used for SF body |
| | | length field. In this case, the body length of a sub-frame ranges |
| | | from 0 to 2047 DWs (0 to 81888 bytes). |
| T | 0.5 | Sub-frame type |
| | | 0: Data |
| | | 1: Control or Command |
| BL[2:0] | 0.2:0 | LSB 3-bit of sub-frame body length in DW. |
| BL[10:3] | 1.7:0 | Optional MSB 8-bit of sub-frame body length. Depend on LI |
| | | bit. |
| SLID[7:0] | 2.7:0 | LSB 8-bit of synchronous link identifier. |
| SLID[15:8] | 3.7:0 | Optional MSB 8-bit of synchronous link identifier. Depend on |
| | | IDI bit. |
| R | 0.4:3 | Reserved for future use. |

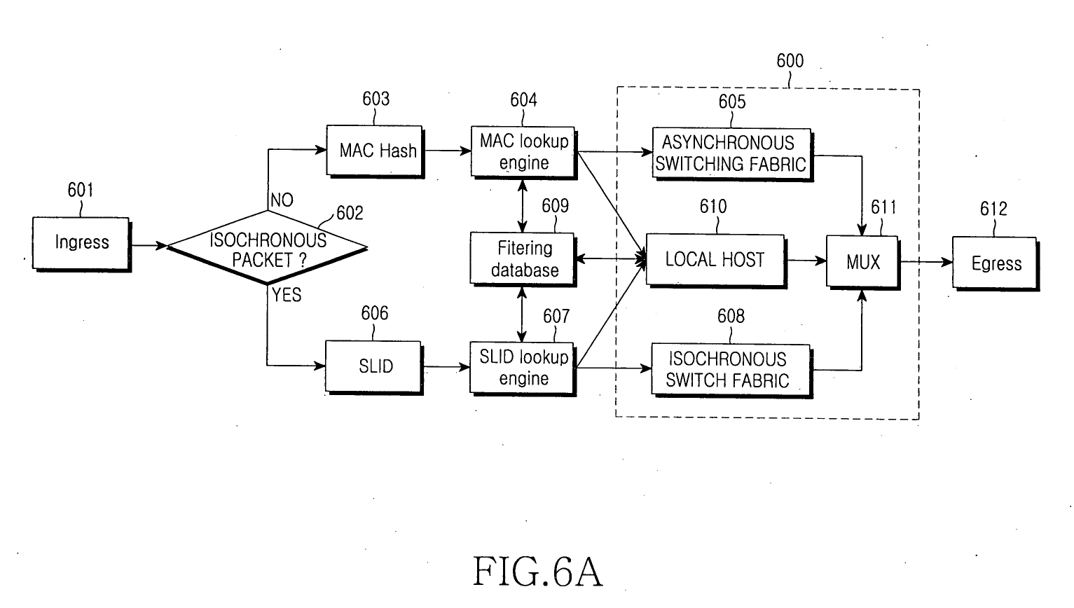

FIG. 5 is a diagram illustrating the construction of a switching table in the RE according to the embodiment.

As illustrated in FIG. 5, all switching records 51-1, 51-2, 51-3, . . . , 51-i, . . . , 51-N are stored according to a corresponding order of an SLID. Each of the switching records 51-1, 51-2, 51-3, . . . , 51-i, . . . , 51-N includes an input port 52, an output port mask 53, a bandwidth limitation 54, and management information 55. Specifically, the input port 52 corresponds to a record about the input port of a sub-frame/SLID. All sub-frames with a corresponding SLID from another port are rejected.

In the output port mask 53, each port of a switching device is represented by one bit. All bits of a destination port are set to “1” and other bits are set to “0”.

The bandwidth limitation 54 is given to the maximum number of DWs in one interval, and is set during a link setup or change. A switching device checks if a cumulative bandwidth of a synchronous link exceeds a limitation during one interval and rejects a bandwidth exceeding the limitation.

The management information 55 includes information for management regarding records including a record effective bit, a record period bit, etc.

Two important operations about a switching table correspond to record learning and aging.

Among the operations, record learning about an isochronous packet is different from that about an asynchronous packet automatically learned from an input asynchronous packet. That is, in the case of an isochronous packet, each switching device chained to a link path must be taken part in while the isochronous packet is established. For example, each switching device learns bandwidth request information from management sub-frames exchanged according to a predetermined link, holds or rejects a bandwidth request according to an available bandwidth, and records a corresponding switching record in the switching table.

Further, aging about an isochronous packet is similar to that of an asynchronous packet. If a switching device receives a synchronous link release command or one synchronous link is deactivated during predefined time period (indicated by a record period bit), a corresponding switching record is deleted and a reserved bandwidth is released.

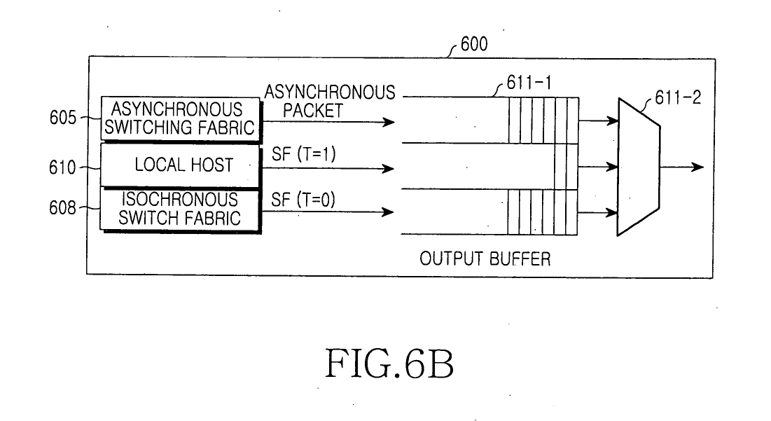

FIGS. 6a and 6b are diagrams illustrating the switching process of a sub-frame in the RE according to the embodiment of the present invention.

Referring to FIG. 6a, a switching device capable of performing the switching of an isochronous packet includes switching parts for the isochronous packet together with switching parts for an asynchronous packet.

Hereinafter, the operation of the switching device will be described. First, packets are input to the switching device through an ingress (601). The input packets are parsed. The switching device analyzes the parsed frame and checks if the packet corresponds to an isochronous packet (602).

If the packet does not correspond to an isochronous packet, the packet is processed by the switching parts for an asynchronous packet. However, if the packet corresponds to an isochronous packet, the packet is processed by the switching parts for an isochronous packet.

First, the switching for an isochronous packet will be described. The isochronous packet is unwrapped into sub-frames, and each sub-frame is transferred to either a local host 610 or a RE switch fabric 608 by the T bit of its control bit.

Specifically, the switching device patches an SLID from the sub-frame (606), accesses a switching table in a filtering database 609 through an SLID lookup engine 607, and obtains the switching record of the corresponding sub-frame.

If the switching record is invalid, the sub-frame is rejected. However, if the switching record is valid, the switching device begins an effectiveness check. The effectiveness check regards whether an ingress is correct and a cumulative bandwidth has not exceeded the limitation of a corresponding link. The switching device determines whether to reject or process the corresponding sub-frame through the effectiveness check.

If the switching operation for the corresponding sub-frame is performed through the effectiveness check, the sub-frame is switched through the isochronous switch fabric 608.

In the meantime, if the frame is proved to be a CMSF through the SLID lookup engine 607, the frame is transferred to the local host 610 instead of the isochronous switch fabric 608. The local host 610 analyzes the frame and processes the frame according to the analysis results. Occasionally, the local host 610 transfers a received CMSF through an egress 612 or generates a new CMSF and transfers the generated CMSF through the egress 612.

In the case of an asynchronous packet, Media Access control (MAC) information is obtained through an MAC hash (603), the filtering database 609 is searched for by means of an MAC lookup engine 604, and the asynchronous packet is transferred to an asynchronous switching fabric 605 or the local host 610.

A MUX 611 multiplexes the sub-frame output from the asynchronous switching fabric 605, the local host 610 and the isochronous switch fabric 608, and forwards the multiplexed sub-frame to the egress 612 according to its output port mask.

All sub-frames from different source ports are newly encapsulated into an isochronous packet again in each egress 612, and are sent at the beginning point of a coming interval. Since the total bandwidth of all synchronous links are under control while all synchronous links are established or altered, and input synchronization traffic is applied through the above-described effectiveness check process, all isochronous sub-frames can be transmitted according to the time. Consequently, in the embodiment of the present invention, it is possible to ensure synchronization and real-time processing.

FIG. 6b is a diagram illustrating in detail of the multiplexing for output according to sub-frames.

Referring to FIG. 6b, in order to multiplex the sub-frame output from the asynchronous switching fabric 605, the local host 610 and the isochronous switch fabric 608, the sub-frame is buffered by an input buffer 611-1, is sequentially multiplexed by a multiplexer 611-2, and is output to the egress 612.

In the method according to the embodiment of the present invention, it is possible to assign a bandwidth more flexibly because a sub-frame has a variable length. Further, a maximum bandwidth is limited only by the total available capacity of a physical link, and a minimum bandwidth is not nearly limited as long as a sub-frame with no data is transferred before a fading-out time of a switching record, during which a synchronous link is maintained, is reached. The bandwidth of an isochronous packet, which is not temporarily used, can be assigned for transmission of an asynchronous packet. This is important for a Variable Bit Rate (VBR) application.

Except for a sub-frame for a link maintenance, which has no data, one DW data sub-frame has the worst BUR. The BUR is 57% (2 byte SLID) or 67% (1 byte SLID). However, if a tolerable data arriving space is more than one interval of 125 μs, its source device can transmit the sub-frame of one 2-DW data every two intervals. In this way, a BUR increases to 73% or 80%.

The embodiment of the present invention as described above proposes a residential Ethernet system based on a new sub-frame. In the residential Ethernet system based on the new sub-frame, a BUR and operation efficiency are considered through the sub-frame.

According to an embodiment of the present invention, a sub-frame has a structure similar to that of a conventional Ethernet frame, and its frame payload can be set to be shorter than in the conventional Ethernet frame (i.e. there exist a frame header of maximum four bytes and a FCS field). All data belonging to one synchronous link are encapsulated into one sub-frame, and a plurality of sub-frames is gathered into one Ethernet frame. It is possible to easily obtain a BUR of more than 80% for a 1.5 Mbps audio CD data stream by a short overhead and a plurality of sub-frames.

In relation to switching efficiency, each sub-frame includes an SLID and a short header having sub-frame length information, a corresponding header includes enough information for a sub-frame switching, similar to a conventional Ethernet frame switching, whose operation efficiency has been proved by its popularity.

The embodiments of the present invention as described above proposes a sub-frame structure for transmission of variable isochronous data, thereby improving a BUR and enabling its construction and operation to be simplified as compared with a slot-based transmission method. Note that the above method according to the embodiments of the present invention can be realized as software and can be stored in a recording medium such as a CD-ROM, an RAM, a floppy disk, a hard disk, or a magneto-optical disk, so that a user can read such software by using a computer. Further, the embodiments of the present invention as described above can variably reduce the size of an Ethernet header, thereby efficiently using its bandwidth.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for generating a super frame of a predetermined size in a residential Ethernet system for separately transmitting isochronous data and asynchronous data, the method comprising the steps of:
receiving by the residential Ethernet system the isochronous data and the asynchronous data to be transmitted through the residential Ethernet system;
dividing the received isochronous data into a plurality of sub-frames according to synchronous links;
inserting an Ethernet header into each of the sub-frames, thereby generating a plurality of isochronous packets; and
employing a remaining area, which is obtained by excepting an area of the isochronous packets from the predetermined size, as an asynchronous packet area, and inserting asynchronous packets including the asynchronous data into the asynchronous packet area.

2. The method as claimed in claim 1, wherein said each of the sub-frames includes a control field, a body length field, a synchronous link identifier field, and a sub-frame body field, the control field providing information for the body length field, the synchronous link identifier field, and a sub-frame type, the body length field indicating a body length of the sub-frame, the synchronous link identifier field indicating a number of synchronous links including the sub-frame, and the sub-frame body field including data to be transmitted through the sub-frame.

3. The method as claimed in claim 2, wherein the control field includes a Length Indicator (LI) field, an IDI field and a T bit field, the LI field indicating if the body length of the sub-frame, which is indicated by the body length field, is larger than a predetermined threshold value, the IDI field indicating if the number of synchronous links indicated by the synchronous link identifier field is larger than a predetermined threshold value, and the T bit field indicating if data transmitted through the sub-frame body field correspond to isochronous data or message data for synchronization control, management and operation.

4. The method as claimed in claim 1, wherein the residential Ethernet system for switching the sub-frame generates a switching table including input port information, output port mask information, bandwidth limitation information, and management information, thereby switching the sub-frame, the input port information including information on an input port of the sub-frame, the output port mask information indicating each port of the residential Ethernet system, the bandwidth limitation information indicating a maximum capacity which may be processed within the predetermined size, and the management information for management regarding records.

5. The method as claimed in claim 4, wherein the management information includes a record effective bit for checking if the record is effective, and a record period bit for indicating duration of the record.
